(19) United States
(12) Patent Application Publication
(10) Pub. No.: US 2019/0226547 A1
(43) Pub. Date: Jul. 25, 2019

(54) Damping Valve For A Vibration Damper

(71) Applicant: ZF FRIEDRICHSHAFEN AG, Friedrichshafen (DE)

(72) Inventors: Aleksandar KNEZEVIC, Eitorf (DE); Jörg RÖSSELER, Ruppichteroth (DE)

(21) Appl. No.: 16/336,052

(22) PCT Filed: Aug. 11, 2017
(86) PCT No.: PCT/EP2017/070445

§ 371 Date: Mar. 22, 2019

(30) Foreign Application Priority Data
Sep. 23, 2016 (DE) 102016218375.3

(51) Int. Cl. F16F 9/348

(52) U.S. Cl. CPC F16F 9/3485

(57) ABSTRACT

A damping valve for a vibration damper, having a damping valve body with at least one through-channel, the outlet side of which is at least partially covered by at least one valve disk. The at least one valve disk lifts from a valve seat surface when there is an incident flow via the through-channel, and a supporting disk, as stop, limits the lift movement. The supporting disk is outfitted with an elastomer support in direction of the valve disk. The elastomer support is formed by a plurality of individual supporting elements. At least one individual supporting element is formed by at least two individual elastomer supports, which are paired to form an individual supporting element.

### CROSS REFERENCE TO RELATED APPLICATIONS

This is a U.S. national stage of application No. PCT/EP2017/070445, filed on Aug. 11, 2017. Priority is claimed on German Application No. DE102016218375.3, filed Sep. 23, 2016, the content of which is incorporated herein by reference.

### BACKGROUND OF THE INVENTION

### 1. Field of the Invention

The invention is directed to a damping valve.

### 2. Description of the Prior Art

A damping valve for a vibration damper comprises a damping valve body with at least one through-channel, the outlet side of which is at least partially covered by at least one valve disk. When the valve side is impinged by flow via the through-channel, the valve disk lifts from a valve seat surface. To protect the valve disk from mechanical overload, at least one supporting disk is generally used as a stop, which limits the lift movement. In the simplest configuration, the supporting disk is constructed as a simple, generally metal, annular disk. In contrast, the valve disk is elastically deformable within limits or is axially movably supported against a spring. Regardless of the construction, the effect whereby the valve disk strikes the supporting disk occurs in damping operation during sudden peak loads. This impact is audible.

One solution is to use a plurality of valve disks in layered arrangement. The layering brings about a supporting function within the stack of disks. A drawback is that an increase in the damping force characteristic occurs in valve disks which tend to be rigid.

A damping valve for a vibration damper, which has an elastomer support constructed as an elastomer ring acting against a stop movement of the valve disk at a supporting ring, is known from the generic DE 18 17 391 B2. In its stop function, the elastomer ring acts as a sealing ring so that there can only be a radial flow of damping medium out of the damping valve.

### SUMMARY OF THE INVENTION

It is an object of one aspect of the present invention to further develop the generic damping valve with regard to a large range of variation of the damping force characteristic.

According to one aspect of the invention at least one individual supporting element is formed by at least two individual elastomer supports, which pair to form an individual supporting element.

The advantage of the paired arrangement consists in that many different combinations are possible with very simple and few different individual supporting elements. Because of the limited installation space in a damping valve, the diameter of which amounts to between approximately 25 mm and approximately 40 mm, very small elastomer supports are also used, and a stepped spring characteristic would be appreciably more difficult to realize with precision in very small elastomer supports than when two individual elastomer supports are used in combination.

One of the individual elastomer supports is preferably constructed as an annular element. An annular geometry can be executed in a simple manner and, accordingly, has at least two variable parameters regardless of the choice of material, namely, e.g., the outer diameter and a cord diameter.

The two individual elastomer supports are arranged concentric to one another so that the supporting surface can be optimally loaded and utilized.

In a further advantageous configuration, there is a radial preloading between the outer individual elastomer support and the inner individual elastomer support. The advantage consists in that only one of the individual elastomer supports need be connected directly to the supporting disk. The other individual elastomer support may be fixed indirectly to the different individual elastomer support via the preloading.

It can be provided that the individual elastomer support having the higher spring rate envelops the individual elastomer support having the lower spring rate. In this way, the outer individual elastomer support stabilizes the inner, softer individual elastomer support.

Alternatively, the individual elastomer support having the lower spring rate envelops the individual elastomer support having the higher spring rate. This arrangement is particularly relevant when a hydraulic damping force effect is to be utilized and the outer individual elastomer support limits a displacer space.

A further possibility for varying the supporting force characteristic consists in that a displacer space surrounded by the outer individual elastomer support has an outlet orifice, which is opened when the outer individual elastomer support is compressed. A varying degree of throttling of the out-flowing damping medium can be achieved through the configuration of the outlet cross section. This throttling force is superposed on the mechanical spring force during the compression of the individual elastomer support.

One possibility is in that the outlet orifice is formed in the supporting disk. The supporting disk is rigid and often made of metallic material. Consequently, the outlet cross section does not change, and the outlet cross section can very easily be manufactured with high precision.

Alternatively, the outlet orifice can be formed in one of the individual elastomer supports of the combined individual elastomer supports. The outlet orifice can be provided already during the injection molding of the individual elastomer support. Accordingly, the additional work step for forming inside of the supporting disk can be omitted.

In addition, it may be provided that a cavity filled with damping medium is provided between a back side of the individual elastomer support and the supporting disk. When the supporting element is compressed, the cavity, which is filled with damping medium, is compressed and generates a damping force. The larger the cavity in relation to the supporting element, the flatter the characteristic line of the achievable damping force.

According to an advantageous subclaim, the two individual elastomer supports form a series arrangement with respect to the spring forces thereof. This construction facilitates assembly and in many cases reduces the installation space requirement.

With respect to a hydraulic damping force component, one of the individual elastomer supports forms an edge with respect to the other individual elastomer support, and the edge limits the displacer space. This results in a comparatively simple component part which affords a hydraulic damping force component in addition to the two spring rates.

### BRIEF DESCRIPTION OF THE DRAWINGS

The invention will be described more fully with reference to the following description of the drawings. The drawings show:

FIG. 1 is a sectional view of a damping valve;

FIG. 2 is a top view of a supporting disk of the damping valve according to FIG. 1;

FIGS. 3-5 are various forms of a supporting disk;

FIG. 6 is a detailed view of FIG. 1;

FIG. 7 is an alternative construction of FIG. 6;

FIG. 8 is a construction principle as in FIG. 7 with fastening of the individual supporting elements on the valve disk; and

FIG. 9 is an individual supporting element with a functional series connection of the individual elastomer supports.

### DETAILED DESCRIPTION OF THE PRESENTLY PREFERRED EMBODIMENTS

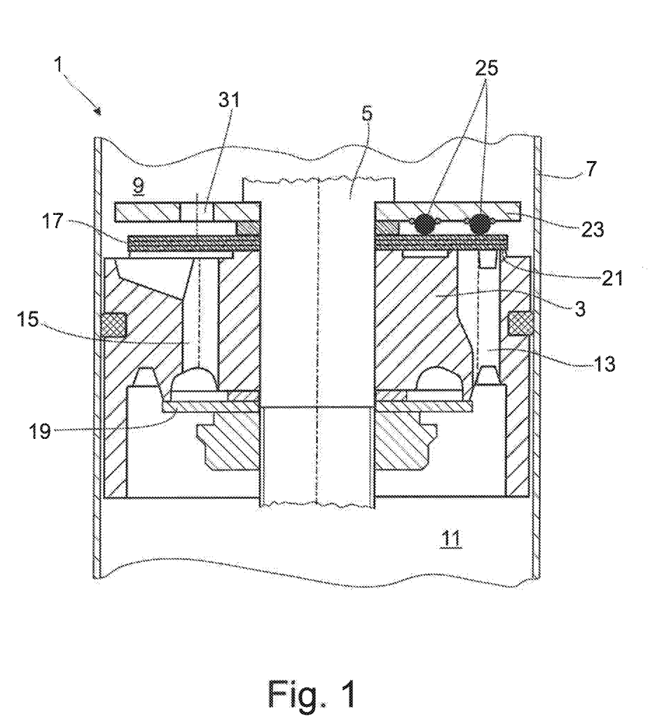

FIG. 1 shows a damping valve 1 for a vibration damper of any type of construction. Damping valve 1 comprises a damping valve body 3, which is fastened to a piston rod 5. The invention is not limited to an embodiment form of this type and can be used, e.g., in a bottom valve or also within the framework of an adjustable damping valve.

Damping valve body 3 divides a cylinder 7 of the vibration damper into a working chamber 9 on the piston rod side and a working chamber 11 remote of the piston rod 5. Both working chambers 9; 11 are filled with damping medium. Through-channels 13; 15, each for a flow direction, are formed on different pitch circles in damping valve body 3. The configuration of the through-channels is to be considered as exemplary only. An outlet side of through-channels 13; 15 is at least partially covered by at least one valve disk 17; 19.

When there is an incident flow against valve disk 17 proceeding from the working chamber 11 remote of the piston rod 5, valve disk 17 lifts from its valve seat surface 21. The lift movement is controlled or braked in a damping manner by a supporting disk 23 in combination with an elastomer support. The elastomer support is formed by a plurality of individual supporting elements 25.

The individual supporting elements 25 are preferably constructed as balls. Barrel-shaped constructions are also advantageous. Both constructional shapes can be mounted in a simple, position-independent manner.

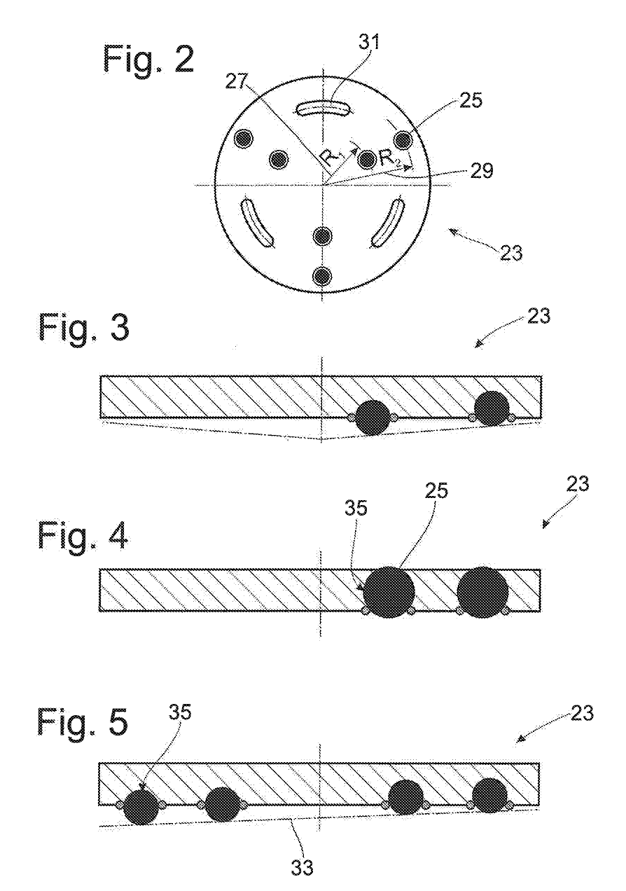

As is shown in FIG. 2, the individual supporting elements 25 are arranged in the supporting disk 23 on different pitch circles 27; 29 with radii R₁ and R₂ and form a stop plane. It will be appreciated that other pitch circle diameters can also be used. A possibility consists in that the supporting disk 23 is formed with axial openings 31 which form a flow path between an upper side of valve disk 17 and the adjoining working chamber 9 (see FIG. 1).

FIGS. 3 and 4 show by way of example that the individual supporting elements 25 and the supporting disk 23 can have a variable axial distance from the valve disk 27 as is shown by the guide lines. It is shown by way of example in FIG. 3 that the lift path is greater at the outer circumference of valve disk 17 than in the central area.

In FIG. 5, the individual supporting elements 25 form a stop plane 33, which is formed as an oblique plane, e.g., in order to achieve a defined lift point of the valve disk 17.

To this end, individual supporting elements 25 with different diameters or effective heights can be provided. However, in case of standardized individual supporting elements 25, it can also be provided that trough-shaped receptacles 35 in the supporting disk 23 for the individual supporting elements 25 have different receptacle depths such that the axial protrusion and, consequently, the distance from the valve disk 17 are determined via the receptacle depth.

Alternatively or in combination, the individual supporting elements 25 can have different spring rates. With a standardized construction of the individual supporting elements 25, the spring rate can be achieved, e.g., through a different Shore hardness of the starting material.

FIG. 4 shows a constructional form of the supporting disk 23 that has axially continuous receptacle openings 25, and the individual supporting elements 25 penetrate the supporting disk 23 with a different protrusion on both sides. A supporting disk of this type can then have two installation positions. Depending on which top side faces in direction of valve disk 17, a determined damping characteristic of the individual supporting elements 25 results.

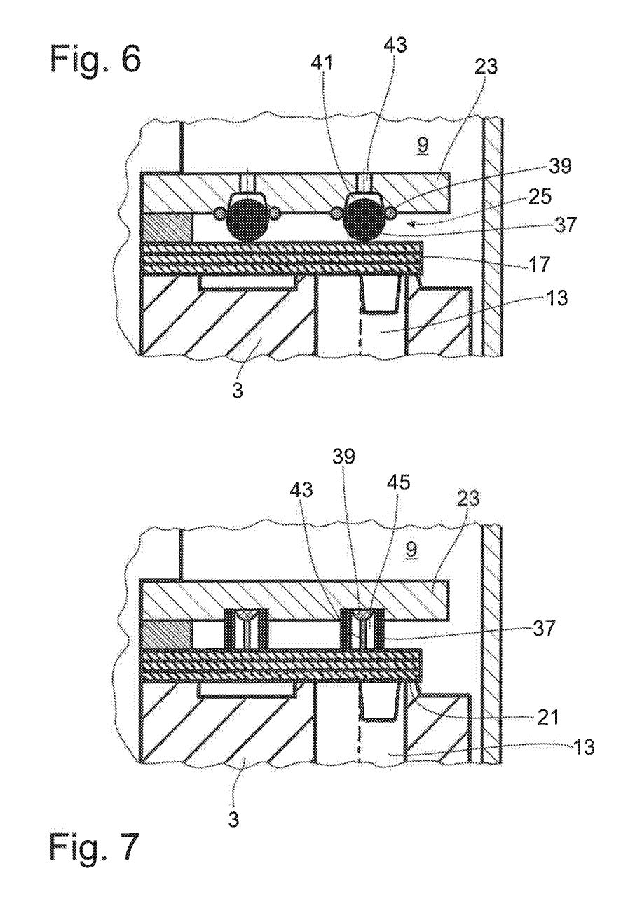

FIGS. 1 to 5 show the basic construction of a possible embodiment form. It will be appreciated from FIG. 6 which shows an enlarged detail from FIG. 1 that each individual supporting element 25 is formed from at least two individual elastomer supports 37; 39, which are paired to form an individual supporting element 25. Given corresponding installation space possibilities and requirement profile, more than two individual elastomer supports 37; 39 can also be bundled to form a supporting element.

As is clearly shown, one of the individual elastomer supports 39 is constructed as an annular element comparable to an O-ring, known per se. The two individual elastomer supports 37; 39 are arranged concentric to one another so that very simple basic bodies can be used. Further, there can be a radial preloading between the outer individual elastomer support 37 and inner individual elastomer support 39. Particularly with very flat individual elastomer supports 39, a recess in the supporting disk 23 for fastening this support can be dispensed with. Fastening is then carried out exclusively via the other individual elastomer support 37.

FIG. 6 shows a variant in which the individual elastomer support 39 having the higher spring rate envelops the individual elastomer support 37 having the lower spring rate. In this respect, it is assumed for the sake of simplicity that a large volume with at least similar basic material results in a lower spring rate.

In FIG. 6, the option of providing a cavity 41 filled with damping medium between a back side of the individual elastomer support 37 and the supporting disk 23 is shown by way of example. An outlet orifice 43 which connects the cavity 41 to working chamber 9 is formed in the supporting disk 23.

During a lift movement of the valve disks 17, the mechanical spring forces of supporting elements 25 or of the two individual elastomer supports 37; 39 and a hydraulic force component which originates in that the damping medium located in cavity 41 is displaced via outlet orifice 43 into working chamber 9 when the inner individual elastomer support 37 is under load become active. The hydraulic force component can be adapted through the shape of the cavity 41 and the dimensioning of the outlet orifice 43 with respect to length and cross section.

In the construction according to FIG. 7, the individual elastomer support 37 with the lower spring rate envelops the individual elastomer support 39 with the higher spring rate. In this case also, a radial preloading between the two individual elastomer supports 37; 39 is meaningful for fixing the inner individual elastomer support 39 in the simplest way.

The outer individual elastomer support encloses a displacer space 45, which has a slot-shaped outlet orifice 43. The slot shape offers the great advantage that the outlet orifice 43 can never be closed through the compression of the outer individual elastomer support 39.

During a lift movement, a relatively small supporting force is first initiated with the outer individual elastomer support 37 and ensures an opening movement even under very low compressive forces within the through-channel 13. If higher compressive forces occur in through-channel 13, the individual elastomer support 39 with the higher spring rate prevents an impact noise. In addition, a hydraulic force component also takes effect because damping medium is discharged from the displacer space 45 through the compression of individual elastomer support 37. Through this division of functions, the entire damping valve can be better adapted to its useful purpose. This operating behavior is particularly important in the damping valves in which a negative pressure must be avoided in a working chamber.

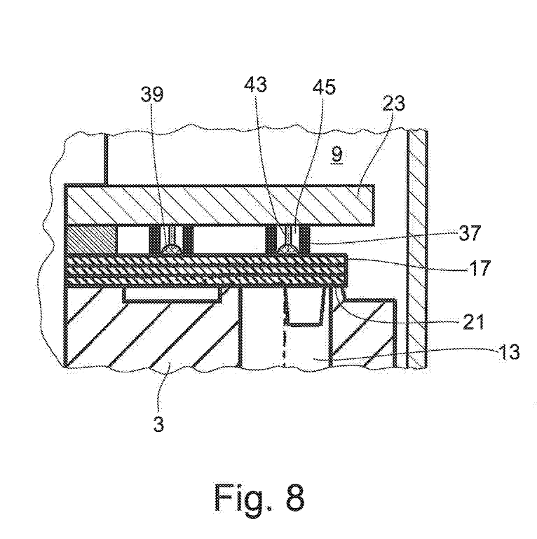

FIGS. 1 to 7 each show damping valves in which the individual supporting elements are fastened with the individual elastomer supports 37; 39 to the supporting disk 23 in direction of the valve disk. It will be appreciated from FIG. 8 that it is also possible in principle to fasten the individual elastomer supports 37; 39 to the upper side of valve disk 17. The functional principle of the construction according to FIG. 8 is identical to the construction according to FIG. 7. Glue or vulcanized joints can be used as a fastener.

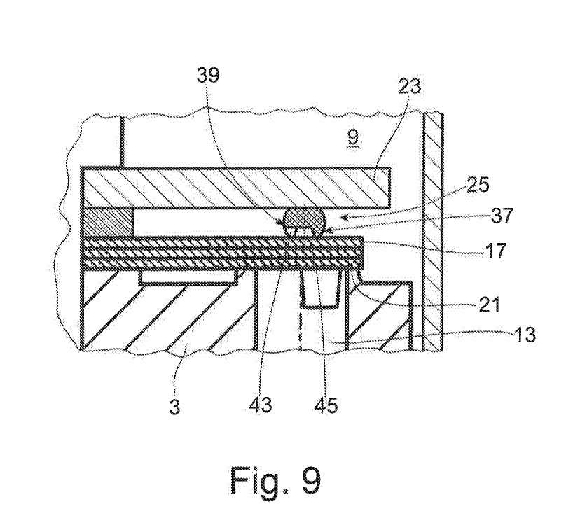

In the construction according to FIG. 9, the individual elastomer supports 37; 39 are inseparably combined to form a one-piece individual supporting element 25. The individual supporting element has a square or spherical individual elastomer support 37 with a circumferential edge forming the individual elastomer support 39. The edge 39 and the individual elastomer support 37 present a crater-like structure so that the displacer space 45 is radially limited by the edge. Edge 39 is radially open and accordingly forms the outlet orifice 43.

In contrast to FIGS. 1 to 8, there is no parallel arrangement of two individual elastomer supports 37; 39 in this case but rather a series arrangement. In principle, the connection between the two individual elastomer supports need not be inseparable. However, it simplifies assembly. Apart from the mechanical spring force, a hydraulic damping force component is also achieved by the configuration of the displacer space 45.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A damping valve for a vibration damper, comprising:
at least one valve disk;
a damping valve body with at least one through-channel, an outlet side of which is at least partially covered by the at least one valve disk, wherein the at least one valve disk lifts from a valve seat surface when there is an incident flow via the through-channel;
a supporting disk configured as a stop to limit lift movement; and
an elastomer support outfitted on one of the at least one valve disk and the supporting disk in a direction of an other of the at least one valve disk and the supporting disk, wherein the elastomer support is formed by a plurality of individual supporting elements,
wherein at least one individual supporting element is formed by at least two individual elastomer supports which are paired to form an individual supporting element.

14. The damping valve according to claim 13, wherein one of the individual elastomer supports is constructed as an annular element.

15. The damping valve according to claim 14, wherein two respective individual elastomer supports are arranged concentrically with respect to each other.

16. The damping valve according to claim 13, wherein there is a radial preloading between an outer individual elastomer support and an inner individual elastomer support.

17. The damping valve according to claim 15, wherein a first individual elastomer support having a higher spring rate envelops a second individual elastomer support having a lower spring rate.

18. The damping valve according to claim 15, wherein a first individual elastomer support having a lower spring rate envelops a second individual elastomer support having a higher spring rate.

19. The damping valve according to claim 16, wherein a displacer space surrounded by the outer individual elastomer support has an outlet orifice which is opened when the outer individual elastomer support is compressed.

20. The damping valve according to claim 19, wherein the outlet orifice is formed in the supporting disk.

21. The damping valve according to claim 19, wherein the outlet orifice is formed in one of the individual elastomer supports of the combined individual elastomer supports.

22. The damping valve according to claim 20, wherein a cavity filled with a damping medium is provided between a back side of the individual elastomer support and the supporting disk.

23. The damping valve according to claim 13, wherein the two individual elastomer supports form a series arrangement with respect to spring forces thereof.

24. The damping valve according to claim 13, wherein one of the individual elastomer supports forms an edge with respect to an other individual elastomer support, wherein the edge limits the displacer space.
